(19) United States
(12) Patent Application Publication
(10) Pub. No.: US 2023/0216321 A1
(43) Pub. Date: Jul. 6, 2023

(54) PORTABLE POWER SYSTEM

(71) Applicant: WORKSPORT LTD., Richmond Hill (CA)

(72) Inventors: Jonathan Loudon, Toronto (CA); Julian Richardson, Flesherton (CA); Jason Macdonald, Toronto (CA); Steven Rossi, Vaughan (CA)

(21) Appl. No.: 18/183,519

(22) Filed: Mar. 14, 2023

Related U.S. Application Data
(63) Continuation of application No. PCT/US2022/025117, filed on Apr. 15, 2022.
(60) Provisional application No. 63/175,860, filed on Apr. 16, 2021.

(51) Int. Cl. H02J 7/00

(52) U.S. Cl. CPC H02J 7/0063; H02J 7/0042; H02J 7/0047

(57) ABSTRACT

A portable power system for powering an appliance connected thereto. The portable power system includes an inverter unit and a rechargeable primary energy storage unit having a first energy storage capacity. The inverter unit includes an inverter, a power outlet, and portions defining a receptacle space configured to releasably receive the primary energy storage unit therein. The inverter unit and the primary energy storage unit are configured to be electrically connected together when the primary rechargeable energy storage unit is received within the receptacle space and to provide electric power to the power outlet. The inverter unit also including a short term energy storage device that is configured to provide electric power to the power outlet and a connected appliance when the primary energy storage unit is released and removed from the inverter unit.

### CROSS-REFERENCE TO RELATED APPLICATIONS

This application is a continuation of international application no. PCT/US2022/025117, filed Apr. 15, 2022, which claims priority to U.S. provisional application no. 63/175,860 filed Apr. 16, 2021, the entire contents of each of which are incorporated herein by reference.

### BACKGROUND

### 1. Field of the Invention

The present invention generally relates to portable power systems.

### 2. Description of Related Art

Portable power systems are devices intended to provide electrical power, from a power source, for use at a site where conventional electrical power may not be readily or conveniently available.

One type of portable power system is a portable generator. Portable generators, however, require an internal combustion engine, fuel and an alternator. The fuel, such a gasoline, is burned by the internal combustion engine and the alternator converts the rotatory output of the engine into electrical energy in the form of an alternating current (AC). If direct current (DC) is desired, the generator may employ a rectifier and various capacitors (as well as other electronic components) to convert the AC power to DC power.

Recently, a second type of portable power system has also been available. These power systems are battery-based systems that receive and store electrical energy from an electrical energy source and provide that electrical energy to a device for the purpose of operating the device or charging the battery of the device.

### SUMMARY

In one aspect, the invention provides a portable power system for powering an appliance connected thereto. The portable power system includes an inverter unit and a rechargeable primary energy storage unit having a first energy storage capacity. The inverter unit includes an inverter, a power outlet, and portions defining a receptacle space configured to releasably receive the primary energy storage unit therein. The inverter unit and the primary energy storage unit being configured to be electrically connected together when the primary rechargeable energy storage unit is received within the receptacle space and to provide electric power to the power outlet. The inverter unit also includes a short term energy storage device that is configured to provide electric power to the power outlet and to a connected appliance when the primary energy storage unit is released and removed from the inverter unit.

In another aspect, the short term energy storage device has a second energy storage capacity, the second energy storage capacity being less than the first energy storage capacity.

In a further aspect, the short term energy storage device has a limited duration of operability when the primary energy storage unit is removed from the inverter unit.

In an additional aspect, the limited duration of operability is greater than fifteen (15) seconds.

In still another aspect, the limited duration of operability is in the range of about fifteen (15) to sixty (60) seconds.

In a further aspect, the short term energy storage device includes a rechargeable battery.

In an additional aspect, the short term energy storage device includes a bank of rechargeable batteries.

In another aspect, the inverter unit includes a housing, the short term energy storage device being enclosed within the housing.

In still a further aspect, the short term energy storage device has an energy storage capacity sufficient to power the appliance during removal and replacement of the primary energy storage unit.

In an additional aspect, the inverter unit further includes a step up converter.

In another aspect, the invention provides a method of powering an appliance using a portable power system, the method comprising the steps of: providing a portable power system including a first rechargeable energy storage unit, a second rechargeable energy storage unit, and an inverter unit, the inverter unit including a short term energy storage device, and the inverter unit being configured to electrically and releasably engage the first and second rechargeable energy storage units at selective and alternate times; powering the appliance with the portable power system and the first rechargeable energy storage unit; disengaging the first rechargeable energy storage unit from engagement with the inverter unit; engaging the second rechargeable energy storage unit with the inverter unit and powering the appliance with the second rechargeable energy storage unit; and from the step of disengaging the first rechargeable energy storage unit until the step of engaging the second rechargeable energy storage unit, powering the appliance with the short term energy storage device.

In another aspect, the short term energy storage device is configured to power the appliance for a limited duration of time.

In yet a further aspect, the limited duration of time is from the step of disengaging the first rechargeable energy storage unit until the step of engaging the second rechargeable energy storage unit with the inverter unit and powering the appliance with the second rechargeable energy storage unit.

In an additional aspect, the limited duration of time is at least fifteen (15) seconds.

In another aspect, the step of powering the appliance with the short term energy storage device occurs for limited duration of time, the limited duration of time being in the range of about fifteen (15) to sixty (60) seconds.

In another aspect, the invention provides a portable power system including a first rechargeable energy storage unit having a first energy storage capacity, a second rechargeable energy storage unit having a second energy storage capacity, and an inverter unit including an inverter and a power outlet. The inverter unit includes portions defining a receptacle space configured to releasably and alternately receive the first and second energy storage units therein. The inverter unit configured to be electrically connected with the one of the first and second rechargeable energy storage units when the one of the first and second rechargeable energy storage units is received within the receptacle space and to provide electric power to the power outlet. Additionally, the inverter unit includes a short term energy storage unit that is configured to provide electric power to the power outlet for a limited duration of time when the first and second energy storage units are released and removed from the inverter unit.

In a further aspect, the short term energy storage device has a third energy storage capacity, the third energy storage capacity being less than the first energy storage capacity and less than the second energy storage capacity.

In another aspect, the limited duration of time is greater than fifteen (15) seconds.

In an additional aspect, the limited duration of time is in the range of about fifteen (15) to sixty (60) seconds.

In a further aspect, the short term energy storage device includes a rechargeable battery or a bank of rechargeable batteries.

In another aspect, the inverter unit includes a housing, the short term energy storage device being retained within the housing.

In an additional aspect, the short term energy storage device has a third energy storage capacity, the third energy storage capacity being sufficient to power the appliance during removal of the first energy storage unit and replacement with the second energy storage unit.

In still a further aspect, the inverter unit further includes a step up converter.

In another aspect, the invention provides a portable power system including a rechargeable first energy storage unit having a first energy storage capacity, a rechargeable second energy storage unit having a second energy storage capacity, and an inverter unit including an inverter and a power outlet. The inverter unit further includes portions defining a receptacle space configured to releasably and alternately receive the first and second energy storage units therein. The inverter unit is configured to be electrically connected with the one of the first and second energy storage units received within the receptacle space and to provide electric power to the power outlet.

In another aspect, the first energy storage capacity is different from the second energy storage capacity.

In a further aspect, the receptacle space is defined on four sides by opposed lateral sidewalls, a bottom wall and a front wall and is open on at least one side.

In an additional aspect, the receptacle space is open on at least two sides.

In another aspect, the first energy storage unit includes a storage unit top wall and the inverter unit includes an inverter unit top wall, the storage unit top wall being flush with the inverter unit top wall when the first energy storage unit is received within the receptacle space.

In a further aspect, the first energy storage unit includes a storage unit rear wall and the inverter unit includes an inverter unit rear wall located on opposing sides of receptacle space, the storage unit rear wall being flush with the inverter unit rear wall when the first energy storage unit is received within the receptacle space.

In another aspect, the invention provides a portable power system including a rechargeable energy storage unit and an inverter unit having an inverter and a power outlet. The inverter unit further includes portions defining a receiving space configured to releasably receive the rechargeable energy storage unit therein The inverter unit is also configured to be electrically connected with the rechargeable energy storage unit when received within the receiving space and to provide electric power to the power outlet. The rechargeable energy storage unit has a handle that is moveable between a first position enabling lifting of the rechargeable energy storage unit and a second position securing the rechargeable energy storage unit to the inverter unit.

In a further aspect, in the second position the handle is flush with an exterior surface of the rechargeable energy storage unit.

In an additional aspect, in the second position the handle is received within a recessed portion of an exterior surface of the rechargeable energy storage unit.

Further objects, features and advantages of this invention will become readily apparent to persons skilled in the art after review of the following description with reference to the drawings and the claims that are appended to inform a part of this specification.

### BRIEF DESCRIPTION OF THE DRAWINGS

FIG. 1 is a front perspective view of a portable power system incorporating the principles of the present invention.

FIG. 2 is another perspective view of the portable power system seen in FIG. 1 and shows an energy storage unit of the portable power system disengaged from an inverter unit of the system.

FIG. 2.1 is an enlarged view of a portion of the portable power system seen in FIG. 3.

FIG. 3 is a perspective view of the energy storage unit apart from the inverter unit of the portable power system.

FIG. 4 is a perspective view of the energy storage unit seen in FIGS. 2 and 3 showing an integrated carrying handle and locking feature thereof.

FIG. 5 is a rear perspective view of the portable power system showing the energy storage unit disengaged from the inverter unit.

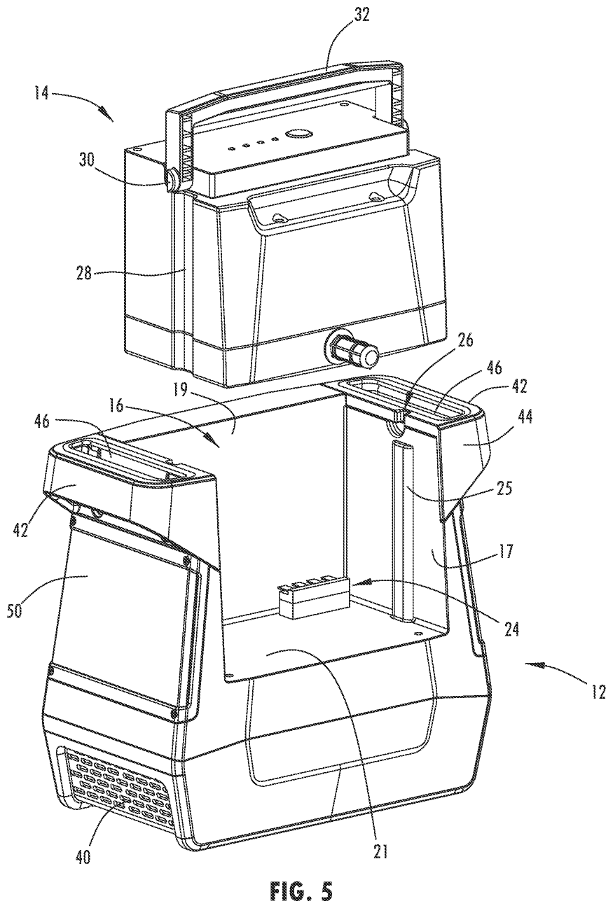

### DETAILED DESCRIPTION

The following description is meant to be illustrative of at least one preferred implementation incorporating the principles of the present invention. One skilled in the art will really appreciate that the invention is susceptible to modification, variation and change without departing from the true spirit and fair scope of the invention. Accordingly, the terminology used herein is intended to be understood in the nature of words of description and not words of limitation. Further, as used in the description that follows, directional terms such as “upper” and “lower” are used with reference to the orientation of the elements as presented in the figures. Accordingly, the term “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part, whether or not such an axis is designated in the figure. An axial surface is therefore one that faces in the axial direction along the central axis. A radial surface therefore faces radially, generally away from or toward the central axis. It will be understood, however, that in actual implementation, the directional references used herein may not necessarily correspond with the installation, orientation or use of the corresponding components or device.

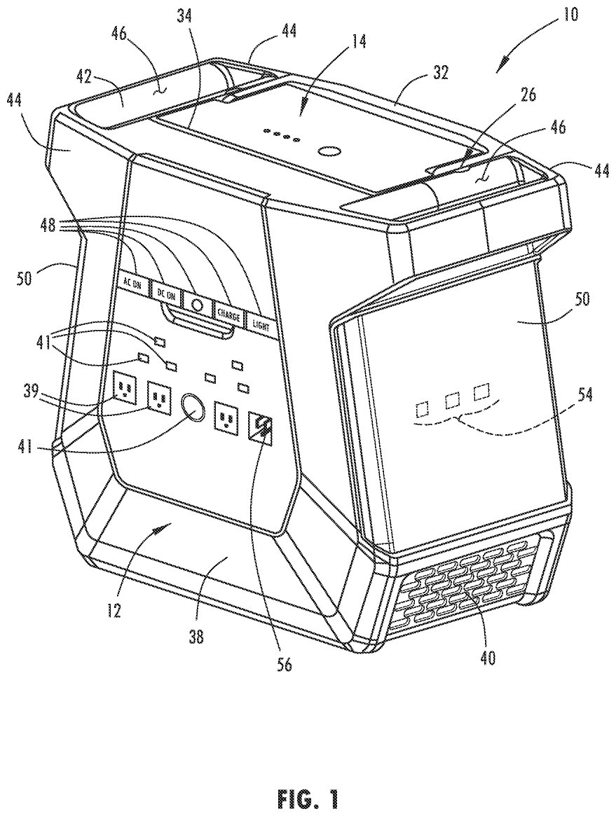

Referring now to the drawings, a portable power system embodying the principles of the present invention is generally illustrated in FIG. 1 and designated at 10. The portable power system 10 includes as its principle components an inverter unit 12 and a removable energy storage unit 14.

The inverter unit 12 includes portions that define a recessed receptacle space 16 for the energy storage unit 14. In this regard, the receptacle space 16 is defined by lateral sidewalls 17, a front sidewall 19 and a bottom wall 21, with the rear and top of the receptacle space 16 being open. The receptacle space 16 further includes features 18 that align, secure and integrate the energy storage unit 14 with the inverter unit 12, as well as features 24 that electrically couple the energy storage unit 14 with the inverter unit 12. The energy storage unit 14 is likewise provided with corresponding alignment, securement and integrating features 22, as well as electrically coupling features 24 that can transmit power and/or data to or from the energy storage unit 14. The features 18 of the receptacle space 16 that align, secure and integrate the energy storage unit 14 with the inverter unit 12 can be provided in various different constructions.

In one non-limiting construction, the features 18 include alignment ridges 25 and locking grooves 26, both provided on the lateral sidewall that defining the receptacle space 16. The corresponding features 22 of the energy storage unit 14 in this construction include alignment grooves 28, into which the alignment ridges 25 are received, and rotatable locking bosses 30.

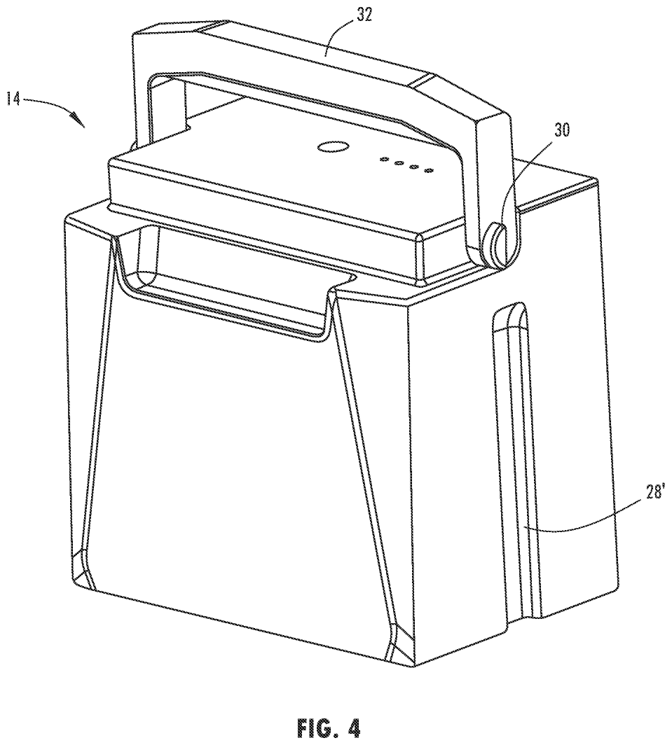

In the illustrated construction, the rotatable locking bosses 30 are provided in the shape of a semicircle on opposing sides of the energy storage unit 14. More specifically, the bosses 30 are provided on a rotatable carrying handle 32 of the energy storage unit 14; the handle 32 also being provided for lifting and removing the energy storage unit 14 from the inverter unit 12. When the handle 32 is in the upward or raised position, as seen in FIG. 4, the energy storage unit 14 may be lifted out of the receptacle space 16 because the semicircle shape of the bosses 30 are oriented to allow the bosses to enter into the open ended, entry/exit straight portion 27 of the locking grooves 26 provided in the lateral sidewalls 17 of the receiving space 16. When the energy storage unit 14 is positioned to be received into the receiving space 16, the alignment ridges 25, which are also formed on the lateral sidewalls 25 of the receiving space 16, are aligned with and received into the alignment grooves 28 on the corresponding sides of the energy storage unit 14. This results in the energy storage unit 14 being positioned relative to the inverter unit 12 for proper engagement of the features 24 that electrically connect the inverter unit 12 and the energy storage unit 14.

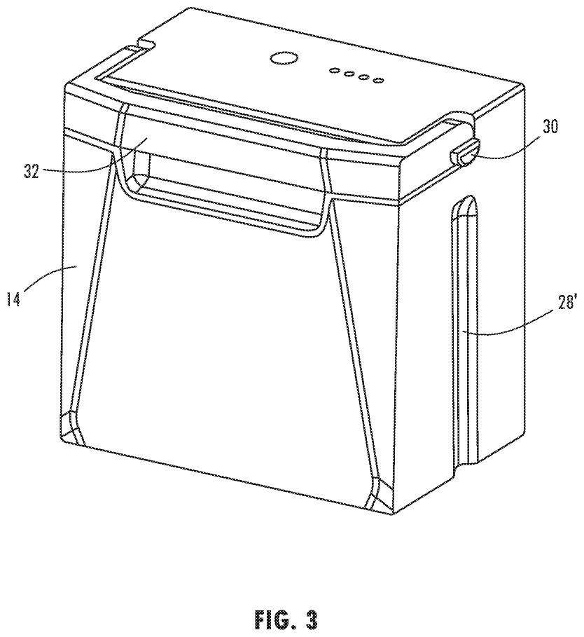

As the energy storage unit 14 is lowered into the receiving space 16, the bosses 30 enter into the straight portion 27 of the locking grooves 26. In one construction, the locking grooves are J-shaped and the bosses 30 are lowered through the straight portions 27 until positioned adjacent to a curved closed ends 29 of the grooves 26. To secure and lock the energy storage unit 14 with the inverter unit 12, the handle 32 is then rotated downward into the locking position, seen in FIGS. 1-3, which results in the bosses 30 being rotated into the curved closed ends 29 of the locking grooves 26. In this position, the locking bosses 30 interact with the locking groove 26 in a manner that prevents retraction of the bosses 30 via the entry/exit straight portion 27of the locking grooves 26, which in turn prevents the removal of the energy storage unit 14 from the inverter unit 12.

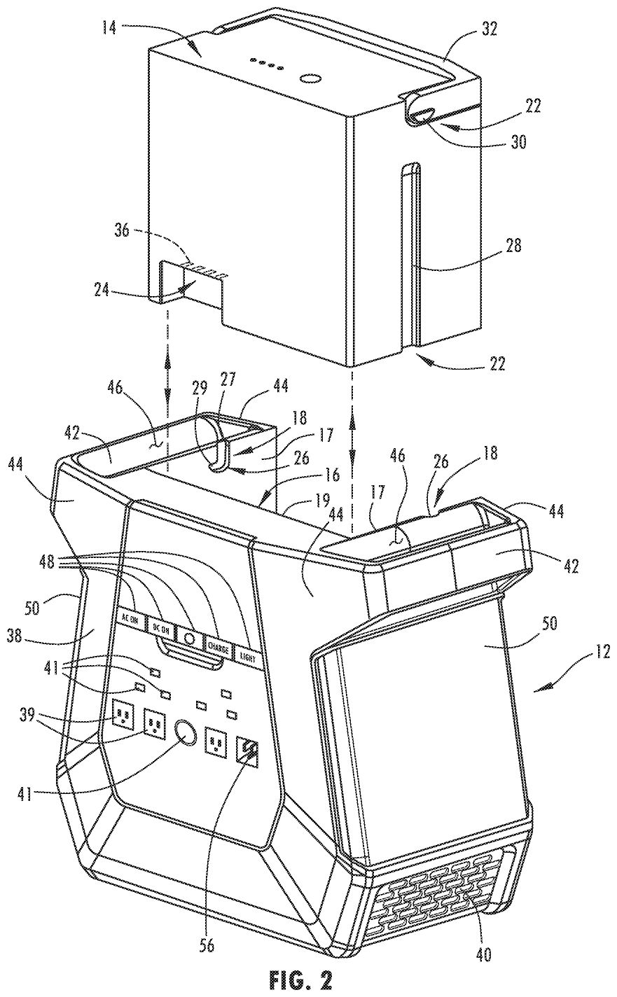

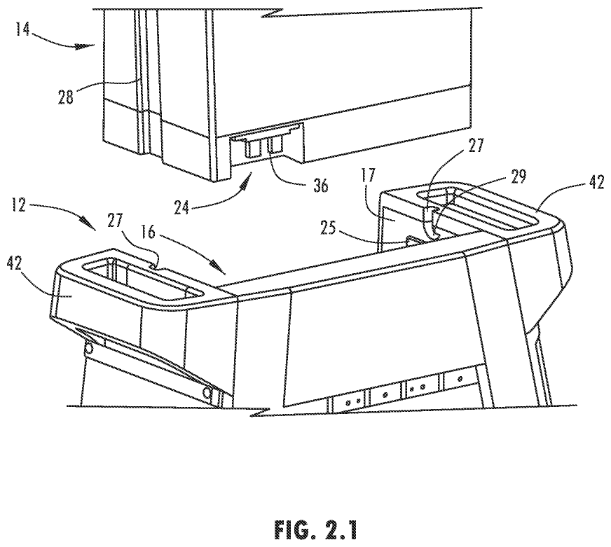

Conversely, moving the handle 32 from the locked position, as seen in FIG. 2, to the unlocked or carrying position, as seen in FIG. 4 will rotate and move the locking bosses 30 out of the curved, closed end portions 29 and into the entry/exit straight portions 27 of the locking groove 26, where they are aligned with the open ends of the grooves 26. The energy storage unit 14 may then be lifted up, out of and away from the inverter unit 12, as shown in FIG. 2.

To prevent inadvertent raising of the handle 32, and potential disengagement of the energy storage unit 14 from the inverter unit 12 while the system 10 is in use, a handle lockout feature may be provided on the energy storage unit 14 or the inverter unit 12. In one embodiment, the handle lockout feature may be simply raised portions on the handle 32 that interferingly engage with raised portions formed on the housing of the energy storage unit 14 or on the lateral sidewalls 17 defining the receptacle space 16. Alternatively, the handle lockout feature may be in the form of a sliding interlock on or engaging with the handle 32.

When the energy storage unit 14 is received in the receptacle space 16 and engaged with the inverter unit 12, a top or top wall of the energy storage unit 14 is flush with the top or top wall of the inverter unit 12. Similarly, when the energy storage unit 14 is received in the receptacle space 16 and engaged with the inverter unit 12, a rear or rear wall of the energy storage unit 14 is flush with the rear or rear wall of the inverter unit 12. This flush configuration with the inverter unit 12 is preferably maintained for all energy storage units 14, regardless of energy capacity, used with the inverter unit 12. Alternatively, at least the flush configuration of the top of the inverter unit 12 is maintained for all energy storage units 14, regardless of energy capacity, used with the inverter unit 12.

Regardless of whether the top and rear walls of the energy storage units 14 are maintained flush with the inverter unit 12, the location of the locking feature 18 on the energy storage units 14 remains the same to ensure engagement with the corresponding feature on the inverter unit 12.

While showing the energy storage unit 14 being installed/uninstalled with the inverter unit 12 from the top of the inverter unit 12, it will be readily appreciated that the energy storage unit 14 and inverter unit 12 can alternatively be configured to engage and disengage with each other from the rear of the inverter unit 12, as well as from the sides or bottom of the inverter unit 12.

The inverter unit 12 integrates a step up converter (DC/DC) and an inverter (DC/AC) with a system controller and various power outlets 39, 41 in a weather resistant plastic shell 38. The inverter provides a pure/clean sine wave AC output to one or more AC outlets 39 (seen in FIGS. 1 and 2) of the inverter unit 12 to power electrical appliances that have current draw and voltage requirements within the specifications of the portable power system 10. In addition to AC outlets 39, the inverter unit 12 may include one or more DC outlets or ports 41, including, but not limited to USB (all varieties) ports, 12 volt auxiliary power sockets (sometimes referred to as cigarette lighter sockets) and various pin/blade connector ports. As used herein, the term electrical appliance is broadly intended to cover any device that is or may be plugged into an AC outlet or DC port so as to be powered for operation of the appliance or for charging of an internal battery of the appliance.

The inverter unit 12 includes a built-in short term energy storage device 52 that allows the inverter unit 12 to operate, uninterrupted, at full power for a limited period of time. In one preferred embodiment, this limited duration of operability is at least fifteen (15) seconds. In another preferred embodiment, the limited duration of operability is about one (1) minute. As such, the limited duration of operability is of a length of time permitting removal of a depleted, or nearly depleted, energy storage unit 14 and replacement with fully charged energy storage unit 14 or one having a greater charge than the removed energy storage unit 14. In one embodiment, the short term energy storage device 52 is a battery bank formed by twenty-four (two rows of twelve) lithium iron phosphate (LiFePO₄) 18650 cells or batteries. Each cell has a nominal voltage of 3.2 V and the maximum energy stored in the energy storage device 52 is 76.8 Wh, with a maximum discharge current of 40 A. The energy storage device 52 is managed by a dedicated battery management system, the details of which are generally well known in the field of the present technology and need not be further described herein.

The lateral sides 50 of the shell 38 are preferably formed of a translucent or transparent material, and operate as lenses for light sources, such as LED light sources 54, located behind the lenses. The light sources 54 may be illuminated via a light on/off button provided on the inverter unit 12, as noted below. The light sources 54 may be provided in one or more of any available or desired color, but white, yellow and red are preferred. A controller within the inverter unit 12 may allow for operation of the light source 54 in differing levels of brightness and/or differing modes, such as a continuous mode or blinking/flashing mode.

The shell 38 of the inverter unit 12 also includes ventilation ports 40 on one or more sides thereof to enable cooling of the step up converter and inverter during and after operation thereof. The ports 40 are configured to provide sufficient air flow into and out of the inverter unit 12 for adequate cooling while minimizing water and dust intrusion.

At the upper lateral sides of the inverter unit 12, the shell 38 is provided with integrally molded, fixed standoff handles 42. The standoff handles 42 are spaced apart from the shell 38 by webs 44 that cooperate to define through openings 46, which allow for the fingers of a user's hand to be comfortably inserted into the openings 44 and around the handles 42. In this way, one or more users may readily carry the inverter unit 12 and/or the portable power system 10.

The front of the inverter unit 12 may include various buttons or switches 48, with corresponding indicator lights, allowing a user to select “Power On”, “AC ON”, “DC ON”, “CHARGE”, “Light” or other functions of the portable power system 10. For example, activation of the POWER ON button may operate as a master on/off switch allowing for activation of either the AC ON or DC ON functionalities and the providing of electrical power to the AC outlet or DC ports only after that particular ON button has been selected. Alternatively, the portable power system 10 can automatically turn on when an energy storage unit 14 has been inserted into the inverter unit 12 or can enter into a standby mode. In another alternative construction, the energy storage unit 14 may include a button requiring its activation in order to place the battery into a READY mode allowing for operation of the power system 10. Activation of the CHARGE switch may allow the controller to effectuate charging of the energy storage unit 14 while the energy storage unit 14 is mounted to the inverter unit 12 and the portable power system 10 is connected to an external power source via an AC power plug 56, provided on the inverter unit 12, and a power cord (not shown).

The energy storage unit 14 is a rechargeable energy storage unit 14 and, as such, may be one of currently known types of rechargeable batteries. Preferably, the rechargeable energy storage unit 14 is a lithium iron phosphate (LiFePO₄) battery, but it will be understood that rechargeable energy storage unit 14 may employ other known rechargeable battery technologies and/or chemistries, such as lithium-ion, including lithium nickel manganese cobalt oxide and lithium manganese cobalt oxide, nickel-metal hydride and others, or may employ yet to be developed rechargeable battery technologies and/or chemistries. Preferably, the energy storage unit 14 is provided in a variety of different electrical capacities, such as 0.5 kWh, 1.0 kWh, 1.5 kWh, 2.0 kWh, 2.5 kWh, etc., with each of the different capacity energy storage units 14 mating and usable with a single inverter unit 12. Accordingly, an end user may possess a number of energy storage units 14 of differing, or the same, electrical capacities for use with a common inverter unit 12; each energy storage unit 14 being configured to engage with the inverter unit 12 via the receptacle space 16.

The electrical connection feature 24 and electrical contacts 36 of the energy storage unit 14, as mentioned above, preferably permit the transfer of data and power to the energy storage unit 14. Accordingly, the electrical connection feature 24 and electrical contacts 36 may also permit the energy storage unit 14, or multiple energy storage units 14, to engage and be charged by an independent and separate charging device or station, such as an automatic battery charger or a solar charger, or by a charging cord that connects with an onboard battery charger via the electrical connection feature 24 and electrical contacts 36. While not shown, the energy storage unit 14 may include status lights indicating when the unit 14 is charged or charging and/or indicating the amount of charge contained therein. Further, the energy storage unit 14 may include a switch allowing the user to select whether the energy storage unit 14 is being charged or not being charged while connected to the charging station or a charging cord.

As a person skilled in the art will readily appreciate, the above description is only meant as an illustration of an implementation of the principles of the present invention. Accordingly, this description is not intended to limit the scope or application of this invention since the invention is susceptible to modification, variation and change, all without departing from the spirit of the invention, as defined in the following claims.

I/we claim:

1. A portable power system, the portable power system comprising:
a primary energy storage unit, the primary energy storage unit being rechargeable and having a first energy storage capacity; and
an inverter unit, the inverter unit including an inverter and a power outlet, the inverter unit including portions defining a receptacle space configured to releasably receive the primary energy storage unit therein, the inverter unit and the primary energy storage unit being configured to be electrically connected together when the primary rechargeable energy storage unit is received within the receptacle space and to provide electric power to the power outlet, the inverter unit further including a short term energy storage device having a second energy storage capacity, the short term energy storage device being configured to allow the inverter unit to operate, at full power in order to provide electric power to the power outlet when the primary energy storage unit is released and removed from the inverter unit.

2. The portable power system of claim 1, wherein the second energy storage capacity is less than the first energy storage capacity.

3. The portable power system of claim 1, wherein the short term energy storage device has a limited duration of operability when the primary energy storage unit is removed from the inverter unit, wherein the limited duration of operability is in a range of about fifteen (15) to sixty (60) seconds.

4. The portable power system of claim 1, wherein the short term energy storage device includes one or more rechargeable batteries.

5. The portable power system of claim 1, wherein the inverter unit includes a housing, the short term energy storage device being enclosed within the housing.

6. The portable power system of claim 1, wherein the short term energy storage device has an energy storage capacity sufficient to power a connected appliance during removal and replacement of the primary energy storage unit.

7. The portable power system of claim 1, wherein the inverter unit further includes a step up converter.

8. The portable power system of claim 1, further comprising a secondary energy storage unit, wherein:
the secondary energy storage unit is rechargeable and has a third energy storage capacity, the receptacle space is configured to releasably and alternately receive the primary and secondary energy storage units therein,
the inverter unit is configured to be electrically connected with the one of the primary and secondary rechargeable energy storage units when the one of the primary and secondary rechargeable energy storage units is received within the receptacle space and to provide electric power to the power outlet,
the short term energy storage device is configured to provide electric power to the power outlet and a connected appliance when the primary and secondary energy storage units are released and removed from the inverter unit.

9. The portable power system of claim 8, wherein the first energy storage capacity and the third energy storage capacity are greater than the second energy storage capacity, the second energy storage capacity being sufficient to power a connected appliance during removal of the primary energy storage unit and replacement with the secondary energy storage unit.

10. A method of powering an appliance using a portable power system, the method comprising the steps of:
providing a portable power system including a first rechargeable energy storage unit, a second rechargeable energy storage unit, and an inverter unit, the inverter unit including a short term energy storage device, and the inverter unit being configured to electrically and releasably engage the first and second rechargeable energy storage units at selective and alternate times;
powering the appliance with the portable power system and the first rechargeable energy storage unit;
disengaging the first rechargeable energy storage unit from engagement with the inverter unit;
engaging the second rechargeable energy storage unit with the inverter unit and powering the appliance with the second rechargeable energy storage unit; and
from the step of disengaging the first rechargeable energy storage unit until the step of engaging the second rechargeable energy storage unit, powering the appliance with the short term energy storage device, wherein the short term energy storage device is configured to allow the inverter unit to operate, uninterrupted, at full power in order to provide electric power to the power outlet between the steps of disengaging the first rechargeable energy storage unit and engaging the second rechargeable energy unit.

11. The method according to claim 10, wherein the short term energy storage device is configured to power the appliance for at least a limited duration of time, and wherein the limited duration of time is from the step of disengaging the first rechargeable energy storage unit until the step of engaging the second rechargeable energy storage unit with the inverter unit and powering the appliance with the second rechargeable energy storage unit.

12. The method according to claim 11, wherein the step of powering the appliance with the short term energy storage device occurs for a limited duration of time, the limited duration of time being in the range of about fifteen (15) to sixty (60) seconds.

13. A portable power system comprising:
a rechargeable first energy storage unit having a first energy storage capacity;
a rechargeable second energy storage unit having a second energy storage capacity; and
an inverter unit including an inverter and a power outlet, the inverter unit including portions defining a receptacle space configured to releasably and alternately receive the first and second energy storage units therein, whereby the inverter unit is configured to be electrically connected with the one of the first and second energy storage units received within the receptacle space and to provide electric power to the power outlet.

14. The portable power system of claim 13, wherein the first energy storage capacity is different from the second energy storage capacity.

15. The portable power system of claim 13, wherein the receptacle space is defined on four sides by opposed lateral sidewalls, a bottom wall and a front wall and is open on at least one side.

16. The portable power system of claim 15, wherein the receptacle space is open on at least two sides.

17. The portable power system of claim 13, wherein the first energy storage unit includes a storage unit top wall and the inverter unit includes an inverter unit top wall, the storage unit top wall being flush with the inverter unit top wall when the first energy storage unit is received within the receptacle space.

18. The portable power system of claim 13, wherein the first energy storage unit includes a storage unit rear wall and the inverter unit includes an inverter unit rear wall located on opposing sides of receptacle space, the storage unit rear wall being flush with the inverter unit rear wall when the first energy storage unit is received within the receptacle space.

19. A portable power system comprising:
a rechargeable energy storage unit;
an inverter unit including an inverter and a power outlet, the inverter unit including portions defining a receiving space configured to releasably receive the rechargeable energy storage unit therein, whereby the inverter unit is configured to be electrically connected with the rechargeable energy storage unit received within the receiving space and to provide electric power to the power outlet;
the rechargeable energy storage unit including a handle, the handle being moveable between a first open position enabling lifting of the rechargeable energy storage unit and a second closed position securing the rechargeable energy storage unit to the inverter unit.

20. The portable power system of claim 19, wherein:
the handle comprises a rotatable locking boss positioned on each side of the rechargeable energy storage unit,
the inverter unit comprises a locking groove that interface with each rotatable locking boss, such that in the second position, the each rotatable locking boss cannot exit the respective locking groove, thus securing the rechargeable energy storage unit to the inverter unit.

21. The portable power system of claim 19, wherein the first position is a substantially vertical orientation and the second position is a substantially horizontal orientation.
